(19) United States
(12) Patent Application Publication
(10) Pub. No.: US 2024/0337972 A1
(43) Pub. Date: Oct. 10, 2024

(54) FIXING DEVICE AND IMAGE FORMING DEVICE

(71) Applicant: Oki Electric Industry Co., Ltd., Tokyo (JP)

(72) Inventor: Hirotaka OHSHIKA, Tokyo (JP)

(73) Assignee: Oki Electric Industry Co., Ltd., Tokyo (JP)

(21) Appl. No.: 18/540,232

(22) Filed: Dec. 14, 2023

(30) Foreign Application Priority Data
Apr. 10, 2023 (JP) 2023-063382

(51) Int. Cl. G03G 15/20

(52) U.S. Cl. CPC G03G 15/2053; G03G 15/2064; G03G 2215/2038

(57) ABSTRACT

A fixing device includes a rotatable annular belt with lubricant on an inner circumferential surface of the annular belt; a pressing roller that is provided to face an outer circumferential surface of the annular belt and makes contact with a part of the outer circumferential surface, thereby forming a nip region between the pressing roller and the annular belt; a thermal diffusion plate that is provided on an inner circumferential side relative to the annular belt and makes contact with a first part of the inner circumferential surface on the pressing roller's side; and a convex part provided so as to make contact with a second part of the inner circumferential surface outside the nip region and on an end part's side in a rotation axis direction of the annular belt.

### BACKGROUND OF THE INVENTION

### 1. Field of the Invention

The present disclosure relates to a fixing device and an image forming device.

### 2. Description of the Related Art

In an image forming device of the electrophotographic type, after an image (referred to also as a developing agent image) formed with a developing agent such as a toner is transferred onto a medium such as a sheet, the image (developing agent image) transferred onto the medium is fixed on the medium by a fixing unit as a fixing device.

In this fixing unit, a heating member in a cylindrical shape formed with a roller, a belt or the like and a pressing member in a cylindrical shape formed with a roller, a belt or the like are rotated while maintaining them in contact with each other, and the image (developing agent image) formed on the medium is heated, fused and fixed on the medium by sandwiching (nipping) the medium between the heating member and the pressing member in a nip region formed between the heating member and the pressing member and heating and pressing the medium while conveying the medium.

In conventional fixing units, a contact member to make contact with an inner circumferential surface of the heating member is provided on an inner circumferential side of the heating member, and the heating member rotates while sliding with respect to the contact member, and thus a lubricant such as grease is applied between the heating member and the contact member. The contact member is, for example, a thermal diffusion member that transmits heat from a heater to the heating member, a guide member that guides the heating member, or the like (see Japanese Patent Application Publication No. 2020-3642, for example).

However, in the conventional fixing units, the lubricant can leak out from an end part of the heating member in its rotation axis direction, and if the lubricant leaking out adheres to an outer circumferential surface of the heating member, heat transmission at the time of fixing the image on the medium can become insufficient and a printing defect can occur.

### SUMMARY OF THE INVENTION

An object of the present disclosure is to provide a fixing device and an image forming device capable of inhibiting occurrence of the printing defects.

A fixing device according to the present disclosure includes a rotatable annular belt with lubricant on an inner circumferential surface of the annular belt; a pressing member that is provided to face an outer circumferential surface of the annular belt and makes contact with a part of the outer circumferential surface of the annular belt, thereby forming a nip region between the pressing member and the annular belt; a contact member that is provided on an inner circumferential side relative to the annular belt and makes contact with a first part of an inner circumferential surface of the annular belt on the pressing member's side; and a contacting member provided so as to make contact with a second part of the inner circumferential surface of the annular belt outside the nip region and on an end part's side in a rotation axis direction of the annular belt.

An image forming device according to the present disclosure includes the above-described fixing device.

In the fixing device in the present disclosure, the contacting member to make contact with a part of the inner circumferential surface of the annular belt outside the nip region is provided at an end part in the rotation axis direction of the annular belt, and thus the lubricant can be inhibited by the contacting member from leaking out from the end part of the annular belt in the rotation axis direction.

According to the present disclosure, a fixing device and an image forming device capable of inhibiting occurrence of the printing defects can be realized.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic cross-sectional view showing the configuration of an image forming device according to an embodiment;

FIG. 2 is a diagram showing the exterior view configuration of a fixing unit according to the embodiment;

FIG. 3 is a diagram showing the configuration of a heating part and a pressing part according to the embodiment;

FIG. 4 is a diagram magnifying a part of the heating part in FIG. 3;

FIG. 5 is a diagram magnifying a part (different from the part shown in FIG. 4) of the heating part in FIG. 3;

FIG. 6 is a diagram showing the configuration of the heating part according to the embodiment;

FIG. 7 is a diagram showing the configuration of a heating belt according to the embodiment;

FIG. 8 is a diagram showing the configuration of supports according to the embodiment;

FIG. 9 is a diagram showing the configuration of a pressing roller according to the embodiment;

FIG. 10 is a diagram showing movement of a lubricant in the heating part according to the embodiment;

FIG. 11 is a diagram magnifying a part of a heating part as a target of comparison;

FIG. 12 is a diagram showing the movement of the lubricant in the heating part as the target of comparison;

FIG. 13 is a diagram showing a configuration example of the heating part according to another embodiment (modification example 1);

FIG. 14 is a diagram showing a configuration example of the heating part according to another embodiment (modification example 1);

FIG. 15 is a diagram showing a configuration example of the heating part according to another embodiment (modification example 2); and

FIG. 16 is a diagram showing a configuration example of the heating part according to another embodiment (modification example 3).

### DETAILED DESCRIPTION OF THE INVENTION

Modes for carrying out the invention (hereinafter referred to as embodiments) will be described in detail below by using the drawings. Further scope of applicability of the present invention will become apparent from the detailed description given hereinafter. However, it should be understood that the detailed description and specific examples, while indicating preferred embodiments of the invention, are given by way of illustration only, since various changes and modifications will become apparent to those skilled in the art from the detailed description.

### 1. CONFIGURATION OF IMAGE FORMING DEVICE

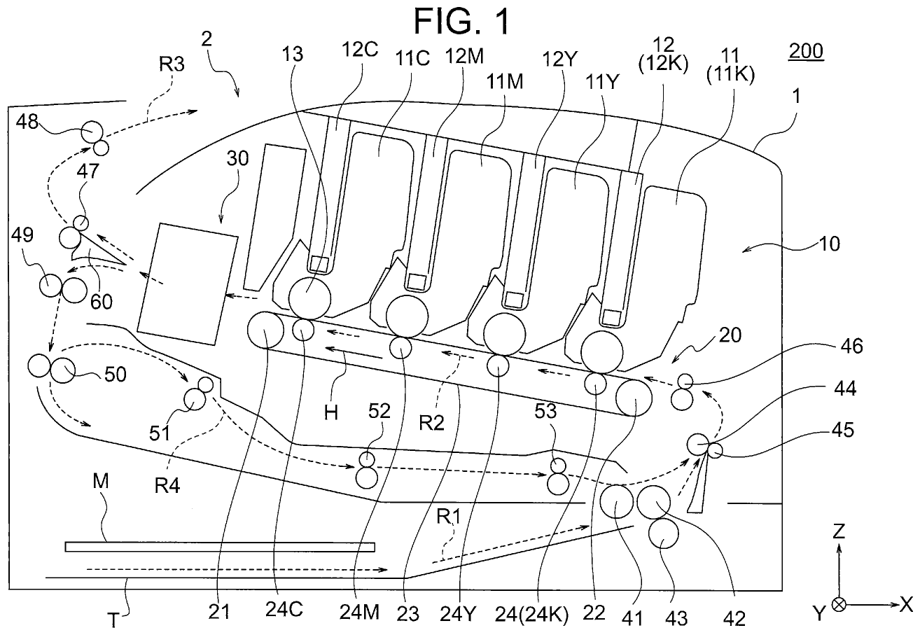

An example of the configuration of an image forming device 200 according to an embodiment is shown in FIG. 1. FIG. 1 is a schematic cross-sectional view showing the configuration of the image forming device 200. The image forming device 200 is a device that forms an image on a medium M by using toners as developing agents, that is, a color printer of the electrophotographic type. While types of the medium M that can be used in the image forming device 200 are not particularly limited, one type or two or more types among paper, film and so forth are usable, for example.

The image forming device 200 has a substantially box-shaped device housing 1. In FIG. 1, a right side of the device housing 1 in the drawing is defined as a front side of the device housing 1, a left side in the drawing is defined as a rear side of the device housing 1, a near side in the drawing is defined as a left side of the device housing 1, and a far side in the drawing is defined as a right side of the device housing 1. Further, a direction heading from the left side towards the right side in FIG. 1 (i.e., a direction heading from the rear side towards the front side of the device housing 1) is defined as a +X axis direction, a direction heading from the near side towards the far side in FIG. 1 (i.e., a direction heading from the left side towards the right side of the device housing 1) is defined as a +Y axis direction, and a direction heading from a lower side towards an upper side in FIG. 1 (i.e., a direction heading from the lower side towards the upper side of the device housing 1) is defined as a +Z axis direction.

A tray T, a development unit 10, a transfer unit 20, a fixing unit 30, various rollers, and a switching guide 60 are provided inside the device housing 1. The various rollers include a pickup roller 41, a sheet feed roller 42, a separation roller 43, a registration roller 44, a pressure roller 45 and conveyance rollers 46 to 53, for example. These various rollers and various rollers described later are cylindrical members extending in the Y-axis direction (transverse direction), and are respectively configured to be rotatable around a rotation axis extending in the Y-axis direction.

The tray T is provided in a bottom part of the device housing 1, and a plurality of media M are stored (i.e., accumulated) in a stacked state in the tray T, for example. Further, an upper surface of the device housing 1 is provided with a stacker 2 onto which the medium M on which an image has been formed is ejected. Inside the device housing 1, conveyance paths R1 to R4 indicated by dotted line arrows in FIG. 1 are formed between the tray T and the stacker 2, and the development unit 10, the transfer unit 20, the fixing unit 30, the various rollers and the switching guide 60 are provided along the conveyance paths R1 to R4.

The image forming device 200 is configured to be capable of forming an image on one surface (front surface) of the medium M and forming images on both surfaces (front and back surfaces) of the medium M by switching a conveyance direction of the medium M by using the switching guide 60. That is, the image forming device 200 has a single-side printing function and a double-side printing function.

In the image forming device 200, the medium M is conveyed in the conveyance direction indicated by the arrow H (i.e., the direction of the dotted line arrow indicating each of the conveyance paths R1 to R4) in each of the conveyance paths R1 to R4.

The conveyance path R1 is a path for conveying the medium M from the tray T to the development unit 10 and the transfer unit 20 provided in an upper part of the device housing 1. The conveyance path R2 is a path for conveying the medium M from the development unit 10 and the transfer unit 20 to the fixing unit 30 provided to the rear of the units 10 and 20 in cases of forming an image on one surface of the medium M. The conveyance path R3 is a path for conveying the medium M from the fixing unit 30 to the stacker 2. The conveyance path R4 is a path for conveying the medium M (making the medium M detour) from the fixing unit 30 to the development unit 10 and the transfer unit 20 again in order to form an image on the back surface of the medium M after forming an image on the front surface of the medium M in cases of forming images on both surfaces of the medium M.

### [1-1. Development Unit]

The development unit 10 and the transfer unit 20 are arranged to face each other in an up/down direction across the conveyance path R2. Specifically, the development unit 10 and the transfer unit 20 are respectively arranged on the upper and lower sides across the conveyance path R2. The development unit 10 is a unit that executes development by using a toner. Specifically, the development unit 10 forms an electrostatic latent image by means of light exposure and executes the development by making the toner adhere to the electrostatic latent image by using Coulomb force.

The development unit 10 includes development processing units 11 each of which executes a development process and exposure processing units 12 each of which executes an exposure process. Each development processing unit 11 is attachable and detachable to/from the device housing 1 and includes a photosensitive drum 13 on which the electrostatic latent image is formed. Each photosensitive drum 13 is a cylindrical member extending in the Y-axis direction and is configured to be rotatable around a rotation axis extending in the Y-axis direction. The exposure processing unit 12, which is provided near the development processing unit 11, forms the electrostatic latent image on the surface of the photosensitive drum 13 by exposing the surface with light. The exposure processing unit 12 includes a light-emitting diode (LED) element, for example, as an exposure means. The development processing unit 11 develops the electrostatic latent image formed on the surface of the photosensitive drum 13 by making the toner adhere to the electrostatic latent image, thereby forming a toner image on the surface.

The development unit 10 includes four development processing units 11 (11K, 11Y, 11M and 11C) and four exposure processing units 12 (12K, 12Y, 12M and 12C), for example. The four development processing units 11K, 11Y, 11M and 11C are arranged in this arrangement order from an upstream side in regard to the conveyance direction indicated by the arrow H, for example. The four exposure processing units 12K, 12Y, 12M and 12C are also arranged in the same arrangement order as the four development processing units 11K, 11Y, 11M and 11C.

The four development processing units 11K, 11Y, 11M and 11C have the same configuration as each other except for difference in the type (color) of the toner used for the development process. Specifically, the four development processing units 11K, 11Y, 11M and 11C respectively execute the development processes by using a black (K) toner, a yellow (Y) toner, a magenta (M) toner and a cyan (C) toner.

### [1-2. Transfer Unit]

The transfer unit 20 is a unit that transfers the toner images developed by the development unit 10 onto the medium M. Specifically, the transfer unit 20 transfers the toner images respectively formed on the photosensitive drums 13 by the development unit 10, onto the medium M conveyed in the conveyance direction indicated by the arrow H.

The transfer unit 20 includes a drive roller 21, an idle roller 22, a transfer belt 23 and transfer rollers 24. The drive roller 21 is configured to be rotatable by a drive source such as a motor. The idle roller 22 is configured to be rotatable according to the rotation of the drive roller 21. The transfer belt 23 is stretched by the drive roller 21, the idle roller 22 and the transfer rollers 24 and is capable of traveling according to the rotation of the drive roller 21. Each transfer roller 24 is pressed against its corresponding photosensitive drum 13 via the transfer belt 23, and when the medium M passes through a position between the photosensitive drum 13 and the transfer belt 23, each transfer roller 24 transfers the toner image formed on the photosensitive drum 13 onto the medium M by electrically charging the medium M in a polarity reverse to that of the toner.

The transfer unit 20 includes four transfer rollers 24 (24K, 24Y, 24M and 24C), for example. The four transfer rollers 24K, 24Y, 24M and 24C are arranged in the same arrangement order as the four development processing units 11K, 11Y, 11M and 11C.

### [1-3. Fixing Unit]

The fixing unit 30 is a unit that fixes the toner images transferred onto the medium M by the transfer unit 20. Specifically, the fixing unit 30 fixes the toner images on the medium M by pressing the medium M, onto which the toner images have been transferred by the transfer unit 20, while heating the medium M. Details of the configuration of the fixing unit 30 will be described later.

### [1-4. Various Rollers and Switching Guide]

The pickup roller 41 is a roller that sends out the medium M from the tray T along the conveyance path R1. The sheet feed roller 42 is a roller that guides (i.e., feeds) the medium M sent out from the tray T by the pickup roller 41 from the conveyance path R1 to the conveyance path R2. The separation roller 43 is a roller that separates an uppermost medium M from other media M in order to feed the uppermost medium M alone when a plurality of media M have been sent out from the tray T.

The registration roller 44 and the pressure roller 45 are rollers that correct skewing of the medium M while conveying the medium M along the conveyance path R2. Each of the conveyance rollers 46-53 is a pair of rollers facing each other via the conveyance path R2-R4, and conveys the medium M along the conveyance path R2-R4. The conveyance roller 48 is a roller (pair) that ejects the medium M, on which the toner images have been fixed, onto the stacker 2.

The switching guide 60 is a guide that is arranged on a downstream side of the fixing unit 30 in regard to the conveyance direction indicated by the arrow H and switches the conveyance direction of the medium M depending on an image formation format (double-side image formation or single-side image formation). Specifically, when an image is formed only on one surface (front surface) of the medium M, the switching guide 60 makes the medium M be conveyed from the conveyance path R2 to the conveyance path R3. In contrast, when images are formed on both surfaces (front and back surfaces) of the medium M, the switching guide 60 makes the medium M be conveyed from the conveyance path R2 to the conveyance path R4.

### [2. Configuration of Fixing Unit]

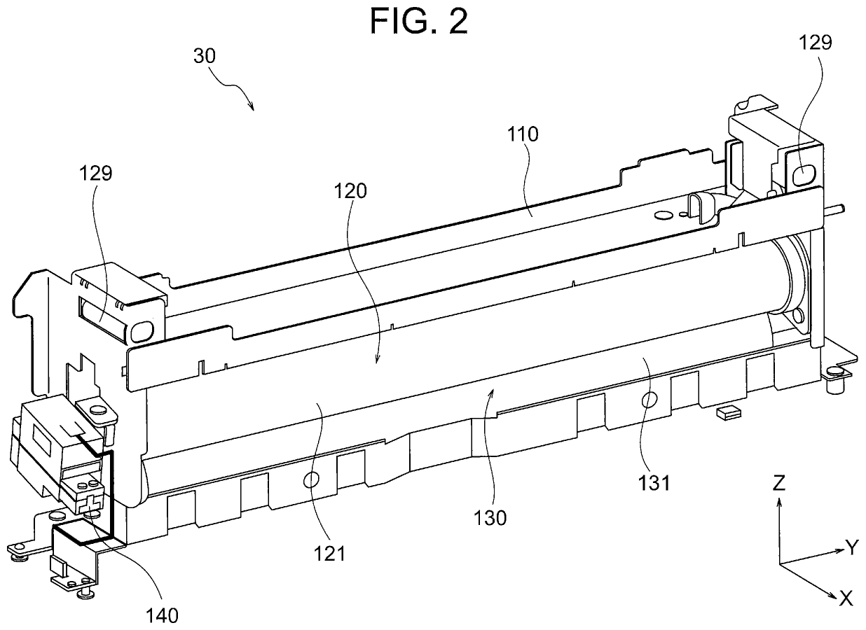

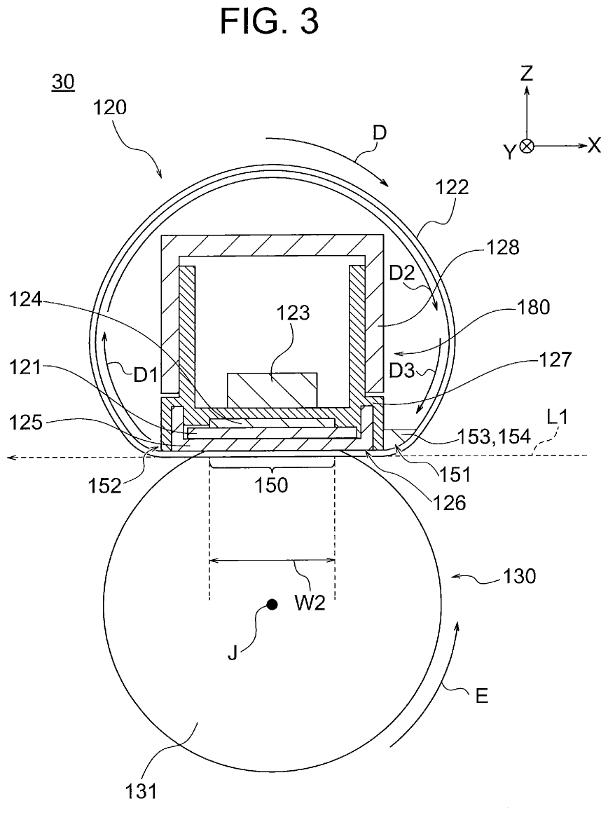

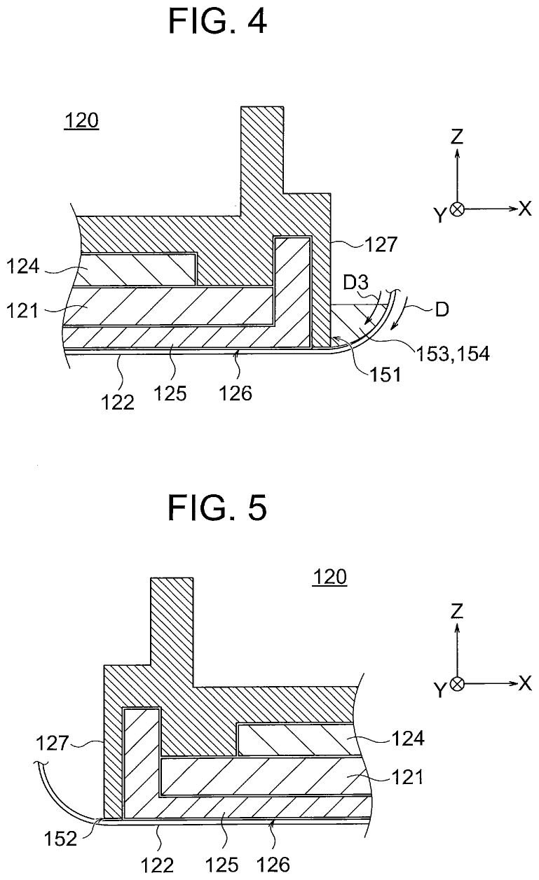

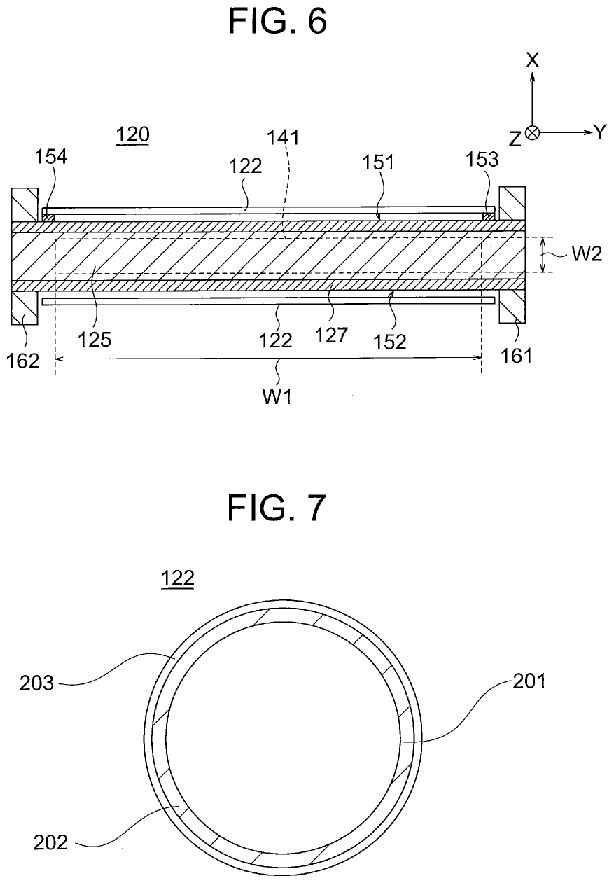

Here, the configuration of the fixing unit 30 will be described in more detail below by using FIG. 2 to FIG. 7. FIG. 2 is a perspective view showing the exterior view configuration of the fixing unit 30. FIG. 3 is a cross-sectional view showing the configuration of a heating part 120 and a pressing part 130 included in the fixing unit 30, and shows a cross section viewed from one end's side in the Y-axis direction (left side). FIG. 4 and FIG. 5 are partially enlarged cross-sectional views magnifying parts in FIG. 3. FIG. 6 is a cross-sectional view of the heating part 120 showing a cross section viewed from one end's side in the Z-axis direction (lower side). While the fixing unit 30 is slightly inclined so that its front side is situated lower than its rear side as shown in FIG. 1, the inclination is omitted in FIG. 2 to FIG. 5 in order to simplify the explanation.

As shown in FIG. 2, the fixing unit 30 has a housing 110 that is long in the Y-axis direction, and includes the heating part 120 and the pressing part 130 inside the housing 110. The housing 110 includes a connector 140 on its side face on one end's side in the Y-axis direction (left side face).

### [2-1. Heating Part]

As shown in FIG. 2, FIG. 3 and FIG. 6, the heating part 120 includes, for example, a heater 121, a heating belt 122 as a rotatable annular belt (i.e., endless belt) with lubricant 126 on an inner circumferential surface of the heating belt 122, a temperature sensor 123, a thermal conduction plate 124, a thermal diffusion member 125, supports 127, 128, 161 and 162, and a pair of compression springs 129. A unit formed by the heater 121, the heating belt 122, the temperature sensor 123, the thermal conduction plate 124, the thermal diffusion member 125 and the supports 127 and 128 among the aforementioned components is referred to as a heater unit 180. While details will be described later, the heating belt 122 is in a shape like a tube extending in the Y-axis direction, and the heater 121, the temperature sensor 123, the thermal conduction plate 124, the thermal diffusion member 125 and the supports 127 and 128 are arranged inside the heating belt 122.

As shown in FIG. 2 and FIG. 6, the heating part 120 extends in the Y-axis direction, and components of the heating part 120, such as the heater 121, also extend in the Y-axis direction in a similar manner. The pair of compression springs 129 (FIG. 2) is a pair of elastic members capable of expanding and contracting in the Z-axis direction, for example. One of the compression springs 129 is attached to one end's side (left end's side) of the housing 110 in the Y-axis direction and one end's side (left end's side) of the heating part 120 in the Y-axis direction, for example, and the other of the compression springs 129 is attached to the other end's side (right end's side) of the housing 110 in the Y-axis direction and the other end's side (right end's side) of the heating part 120 in the Y-axis direction, for example.

The heating part 120 is configured to be movable in the Z-axis direction and biased by the pair of compression springs 129 in a direction of approaching the pressing part 130 (specifically, downward) so that the heating part 120 is pressed against the pressing part 130 when heating the medium M. With this configuration, a nip part 150 is formed between the heating part 120 and the pressing part 130 (specifically, between the heating belt 122 and a pressing roller 131) as shown in FIG. 3.

### [2-2. Heater]

The heater 121 of the heating part 120 generates heat for heating in order to heat the heating belt 122. The heater 121 is supplied with electricity from the outside of the fixing unit 30 via the connector 140. While the type of the heater 121 is not particularly limited, the heater 121 is a planar heater or the like, for example.

### [2-3. Heating Belt]

The heating belt 122 is a belt in a cylindrical shape as a whole (having a cross section in a ring shape) that is heated by the heat generated by the heater 121. As shown in FIG. 3, the heating belt 122 rotates in a belt rotation direction indicated by the arrow D in FIG. 3 while being heated by the heater 121.

Specifically, as its cross section viewed from one end's side in its lengthwise direction is shown in FIG. 7, the heating belt 122 is a laminated body obtained by stacking a base member 201 made with metal such as stainless steel (SUS), heat-resistant resin (polyimide), or the like, an elastic layer 202 made with silicone rubber or the like, and a surface layer 203 such as a PFA (tetrafluoroethylene-perfluoroalkylvinylether copolymer) tube in this arrangement order, for example.

### [2-4. Temperature Sensor]

The temperature sensor 123 is a sensor that detects a temperature (heating temperature) of the heater 121 situated under the temperature sensor 123. Since the thermal conduction plate 124 lies between the heater 121 and the temperature sensor 123, the temperature sensor 123 detects the temperature of the heater 121 via the thermal conduction plate 124.

### [2-5. Thermal Conduction Plate]

The thermal conduction plate 124 is a plate-like member that is arranged between the heater 121 and the temperature sensor 123 and conducts the heat generated by the heater 121 to the temperature sensor 123. The thermal conduction plate 124 is a metallic plate made with stainless steel (SUS) or the like, for example, and is placed in contact with an upper surface of the heater 121 and a lower surface of the temperature sensor 123.

### [2-6. Thermal Diffusion Member]

The thermal diffusion member 125 is a plate-like member (i.e., a thermal diffusion plate) arranged between the heater 121 and the heating belt 122 to separate the heating belt 122 from the heater 121. The thermal diffusion member 125 is placed in contact with a lower surface of the heater 121 and an inner circumferential surface of the heating belt 122. That is, the thermal diffusion member 125 is configured to make contact with a lower part (a part on the pressing part 130's side) included in the entire inner circumferential surface of the heating belt 122. In other words, the heater 121 and the pressing part 130 face each other across the thermal diffusion member 125 and the heating belt 122.

The thermal diffusion member 125 is a member that has thermal conductivity and conducts the heat generated by the heater 121 to the heating belt 122. Specifically, the thermal diffusion member 125 is a metallic plate made with stainless steel (SUS) or the like and coated with glass, for example, and has high thermal conductivity. The thermal diffusion member 125 functions as a thermal diffusion plate that diffuses the heat generated by the heater 121 when conducting the heat to the heating belt 122. Accordingly, the heat generated by the heater 121 is dispersed and conducted to the heating belt 122, and thus the heating belt 122 is heated uniformly and temperature unevenness becomes unlikely to occur on the heating belt 122.

### [2-7. Lubricant]

The lubricant 126 is a liquid lubricant for letting the heating belt 122 smoothly slide with respect to the thermal diffusion member 125 in the state in which the heating part 120 is pressed against the pressing part 130. The lubricant 126 lies between the heating belt 122 and the thermal diffusion member 125. Specifically, the lubricant 126 is applied to a lower surface of the thermal diffusion member 125 (i.e., surface making contact with the heating belt 122). The lubricant 126 is supplied to a gap between the heating belt 122 and the thermal diffusion member 125 due to the rotation of the heating belt 122 at the start of the printing by the image forming device 200. Accordingly, the lubricant 126 reduces the friction drag between the heating belt 122 and the thermal diffusion member 125 when the heating belt 122 slides with respect to the thermal diffusion member 125.

The lubricant 126 may contain one or two or more types of additives in addition to the aforementioned liquid lubricant, for example. Further, as shown in FIG. 6, in regard to an application region 141 when the lubricant 126 is applied to the thermal diffusion member 125, the length W1 in the Y-axis direction (lengthwise direction of the thermal diffusion member 125, that is, the transverse direction) equals the width of the medium M, and the length in the X-axis direction (short-side direction of the thermal diffusion member 125, that is, a forward/backward direction) equals the length W2 of the nip part 150, for example.

After the lubricant 126 is applied to the application region 141, the lubricant 126 gradually moves in the direction indicated by the arrows D1, D2 and D3 as shown in FIG. 3 accompanying the rotation of the heating belt 122 in the arrow D direction and gradually spreads to the whole circumference of the inner circumferential surface of the heating belt 122.

### [2-8. Supports]

As shown in FIG. 3, the support 127 is a member that supports the heater 121. The support 128 is a member that holds the support 127, and is fixed to the housing 110. Each of the supports 127 and 128 is a member extending in the Y direction whose cross section is substantially in a square U shape. The supports 127 and 128 are combined together so that the support 128 is on the upper side and the support 127 is on the lower side to form a shape like a quadrangular tube as a whole.

The temperature sensor 123 is attached to the support 127. Further, the lower surface of the support 127 facing the heating belt 122 is provided with a recess extending in the Y-axis direction, and the heater 121, the thermal conduction plate 124 and the thermal diffusion member 125 are arranged in the recess. Thus, as shown in FIG. 4 and FIG. 5, both end parts of the support 127 in the X-axis direction (the short-side direction, nemely, the forward/backward direction) are respectively situated outside both end parts of the thermal diffusion member 125 in the X-axis direction (the short-side direction, namely, the forward/backward direction). That is, the support 127 is configured so that lower surfaces of its both end parts in the X-axis direction make contact with the inner circumferential surface of the heating belt 122. As shown in FIG. 3, the lower surfaces of the both end parts of the support 127 in the X-axis direction (i.e., the parts making contact with the inner circumferential surface of the heating belt 122) are respectively situated on the upstream side and the downstream side relative to the nip part 150 in the belt rotation direction of the heating belt 122 (the arrow D direction).

Here, as shown in FIG. 3 to FIG. 6, corner parts respectively formed by the lower surfaces of the both end parts in the X-axis direction of the support 127 and the both end faces in the X-axis direction of the support 127 are defined as edge parts 151 and 152. Of these, the edge part 151 is an edge part situated on the upstream side when the heating belt 122 rotates in the belt rotation direction (i.e., the upstream side in the belt rotation direction), and the edge part 152 is an edge part situated on the downstream side in the belt rotation direction. These edge parts 151 and 152 are provided vertically so as to make contact with the inner circumferential surface of the heating belt 122.

As shown in FIG. 6, on the support 127, convex parts 153 and 154 projecting in the X-axis direction (towards the upstream side in the belt rotation direction) are respectively provided on both end parts in the Y-axis direction (rotation axis direction of the heating belt 122) of the edge part 151 on the upstream side in the belt rotation direction.

As shown in FIG. 4, the convex parts 153, 154 are each configured to have a lower surface which is in an arc-like shape as viewed, for example, and which makes contact with the inner circumferential surface of the heating belt 122. Further, as shown in FIG. 6, each of the convex parts 153 and 154 is in a quadrangular shape as viewed in the Z-axis direction, for example, and their inner surfaces facing each other (i.e., surfaces of the central part side on the heating belt 122 in the rotation axis direction) are orthogonal to the Y-axis direction (i.e., the rotation axis direction of the heating belt 122).

The convex parts 153 and 154 are desired to be respectively provided at positions as close as possible to both ends of the heating belt 122 in the Y-axis direction. Further, the convex parts 153 and 154 may be formed either by integral molding together with the support 127 or by attaching parts for serving as the convex parts 153 and 154 to the support 127.

As shown in FIG. 6, the supports 161 and 162 are members for supporting the heating belt 122, and are respectively provided at both end parts of the heating part 120 in the Y-axis direction (the lengthwise direction, namely, the transverse direction). That is, the supports 161 and 162 are respectively provided at one end part's side and the other end part's side in the rotation axis direction of the heating belt 122 so as to support both end parts of the heating belt 122 in the rotation axis direction.

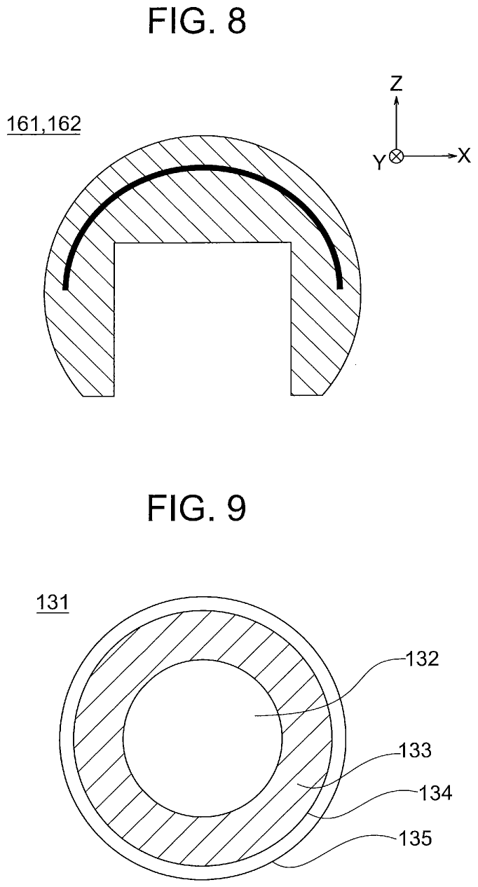

As shown in FIG. 8 which shows each support 161, 162 viewed in the Y-axis direction, each support 161, 162 is configured to have a belt insertion part (a part indicated by a black bold line in FIG. 8) to be inserted into the heating belt 122's side. The belt insertion part is shaped like a semicircle obtained by cutting away the lower half of a circle. The belt insertion part is inserted into an inner side of the heating belt 122 and makes contact with the inner circumferential surface of the heating belt 122.

Further, each support 161, 162 as viewed in the Y-axis direction is in a substantially C-shape pointing its opening downward, and a concavity in a quadrangular shape is formed inside the belt insertion part. The supports 161 and 162 are configured so that both end parts of the supports 127 and 128 in the lengthwise direction are fit in the concavities.

Furthermore, as shown in FIG. 6, the supports 161 and 162 are configured to prevent the heating belt 122 from being excessively displaced in the Y-axis direction even when the heating belt 122 tends to deviate in the Y-axis direction, by having an outer part of the belt insertion part (referred to as a belt contact part) make contact with one end or the other end of the heating belt 122 in the Y-axis direction.

The convex part 153, 154 of the above-described support 127 is provided on a central side of the support 127 in the Y-axis direction relative to the belt contact part of the support 161, 162. Further, the convex part 153, 154 is provided on an outer side in the Y-axis direction relative to the application region 141 of the lubricant 126. Furthermore, as shown in FIG. 3, the convex parts 153 and 154 are provided on an upstream side in the belt rotation direction relative to the nip part 150.

### [2-9. Pressing Part]

As shown in FIG. 3, the pressing part 130 is specifically a pressing roller 131. The pressing roller 131 is a roller extending in the Y-axis direction. The pressing roller 131 is a cylindrical member that can be rotated around a rotation axis J extending in the Y-axis direction by a drive source (not illustrated) such as a motor. As mentioned earlier, the pressing roller 131 is pressed against the heater 121 across the thermal diffusion member 125 and the heating belt 122, thereby forming the nip part 150. The dotted line arrow L1 shown in FIG. 3 indicates a conveyance path of the medium M in the fixing unit 30.

As shown in FIG. 9 which shows a cross section of the pressing roller 131 viewed from one end's side in the lengthwise direction, the pressing roller 131 is a coated roller obtained by stacking an elastic layer 133 made with silicone rubber, a primer layer 134, and a surface layer 135 such as a PFA tube in this arrangement order on the surface of a cylindrical core bar 132 made with free-cutting steel (SUM) or the like.

For the primer layer 134, non-conductive RTV silicone rubber with a thickness less than or equal to 5 μm is used. For the surface layer 135, a non-conductive PFA tube with a thickness of 15 to 25 μm is used. The thickness of the elastic layer 133 is set at 3 mm, and the pressing roller 131 with a total outer diameter of Φ30 is used.

When the pressing roller 131 is pressed against the heating belt 122, each of the surface layer 135, the primer layer 134 and the elastic layer 133 is deformed and contracted due to being pressed against the heating belt 122, and thus the pressing roller 131 forms the nip part 150 at the part making contact with the heating belt 122.

### [2-10. Other Components]

The fixing unit 30 described above may include one or two or more types of other desired components in addition to the above-described components. The other components mentioned here can include a control unit that controls the operation of the fixing unit 30, for example. This control unit includes a temperature control circuit that controls the temperature of the heater 121 via the temperature sensor 123, an electricity supply circuit that supplies electric current to the heater 121, and so forth, for example. The description about the configuration of the fixing unit 30 is as given above.

### 3. OPERATION OF IMAGE FORMING DEVICE

Next, the overall operation of the image forming device 200, the operation of the fixing unit 30, and the movement of the lubricant 126 will be described below in sequence as the operation of the image forming device 200. The overall operation of the image forming device 200 will be described first.

When forming an image on a medium M, the image forming device 200 executes a development process, a transfer process and a fixing process in sequence. Specifically, the image forming device 200 first makes the pickup roller 41 send out a medium M stored in the tray T and thereafter guides the medium M from the conveyance path R1 to the conveyance path R2.

Here, as the development process, the image forming device 200 forms the electrostatic latent images respectively on the surfaces of the photosensitive drums 13 of the development unit 10 and thereafter forms the toner images by developing the electrostatic latent images by making the toners respectively adhere to the electrostatic latent images.

Subsequently, as the transfer process, the image forming device 200 makes the transfer unit 20 transfer the toner images respectively formed on the surfaces of the photosensitive drums 13 onto the medium M. Finally, as the fixing process, the image forming device 200 makes the fixing unit 30 fix the toner images transferred onto the medium M on the medium M by means of heating and pressing. By this operation, an image is formed (i.e., printed) on the medium M. The medium M on which the image has been formed as above is ejected onto the stacker 2 of the image forming device 200. The overall operation of the image forming device 200 is as described above.

Next, details of the operation of the fixing unit 30 will be described below. When heating the medium M, the fixing unit 30 moves the heating part 120 to approach the pressing part 130. At that time, the pressing roller 131 is pressed against the heating belt 122, by which the nip part 150 is formed. Here, in the fixing unit 30, the medium M is supplied to the upstream side in the belt rotation direction (right side in FIG. 3) of the nip part 150 along the conveyance path indicated by the dotted line arrow L1 in FIG. 3. At that time, the fixing unit 30 conveys the medium M, which has been supplied to the upstream side in the belt rotation direction of the nip part 150, to the upstream side in the belt rotation direction of the nip part 150 by the rotation of the heating belt 122 in the belt rotation direction indicated by the arrow D accompanying the rotation of the pressing roller 131. At that time, in the fixing unit 30, the heat generated by the heater 121 is conducted to the heating belt 122 via the thermal diffusion member 125, by which the heating belt 122 is heated up. Accordingly, the medium M passing through the nip part 150 (i.e., passing between the heating belt 122 and the pressing roller 131) is heated while being pressed, and the toner images are fixed on the medium M at that time. The details of the operation of the fixing unit 30 are as described above.

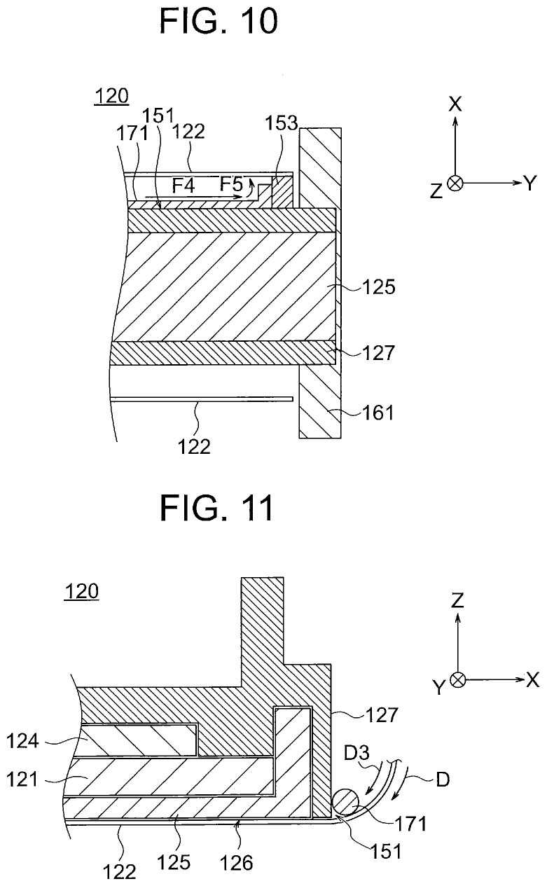

Finally, the movement of the lubricant 126 in the fixing unit 30 will be described below by using FIG. 3 to FIG. 6 and FIG. 10. FIG. 10 is a partially enlarged view magnifying a part (specifically, one end part in the Y-axis direction) of the heating part 120 shown in FIG. 6.

At the time of assembly of the heating part 120, the lubricant 126 is applied to the application region 141 (FIG. 6) of the thermal diffusion member 125. The lubricant 126 applied to the application region 141 is sandwiched and pressed between the thermal diffusion member 125 and the heating belt 122. Thereafter, when the power of the image forming device 200 is turned on, the pressing roller 131 is rotated in a roller rotation direction indicated by the arrow E in FIG. 3 by the drive source (not illustrated). At that time, the heating belt 122 rotates in the belt rotation direction indicated by the arrow D accompanying the rotation of the pressing roller 131.

With the rotation of the heating belt 122, the lubricant 126 adhering to the inner circumferential surface of the heating belt 122 gradually moves in the direction indicated by the arrows D1, D2 and D3 and is conveyed to the edge part 151 (FIG. 3, FIG. 4, FIG. 6) situated on the upstream side in the belt rotation direction of the support 127. Part of the lubricant 126 conveyed to the edge part 151 is scraped off by the edge part 151 without entering the gap between the thermal diffusion member 125 and the heating belt 122.

Since part of the lubricant 126 is scraped off by the edge part 151 as above each time the heating belt 122 rotates, a lubricant puddle 171 develops on the upstream side in the belt rotation direction (upper side in FIG. 10) of the edge part 151 as shown in FIG. 10.

The lubricant puddle 171 gradually increases in volume with the rotation of the heating belt 122, and on the upstream side of the edge part 151 in the belt rotation direction, the lubricant puddle 171 is conveyed in such a way as to be pushed in the direction (the direction indicated by the arrow F4) from the central part side of the heating belt 122 in the rotation axis direction (the Y-axis direction) towards one end part of the heating belt 122 in the rotation axis direction. The lubricant puddle 171 approaches the one end part of the heating belt 122 in the rotation axis direction and then arrives at the convex part 153 provided at the one end part of the edge part 151 in the rotation axis direction. The convex part 153 is provided so as to seal a gap between the edge part 151 and the heating belt 122. Thus, the lubricant puddle 171 is blocked by the convex part 153, changes its moving direction to the direction indicated by the arrow F5 orthogonal to the direction indicated by the arrow F4, and remains in the vicinity of the convex part 153.

As above, the lubricant puddle 171 is generated, by the scraping of the lubricant by the edge part 151, on the upstream side of the edge part 151 in the belt rotation direction, the lubricant puddle 171 is conveyed in the direction from the central part side of the heating belt 122 in the rotation axis direction towards the one end part of the heating belt 122 in the rotation axis direction, and the lubricant puddle 171 then arrives at the convex part 153 situated on the central part side in the rotation axis direction relative to the one end of the heating belt 122 in the rotation axis direction to be blocked by the convex part 153 and remain in the vicinity of the convex part 153.

While the movement of the lubricant 126 in the one end part of the heating part 120 in the rotation axis direction has been described here by using FIG. 10, the movement of the lubricant 126 in the other end part of the heating part 120 in the rotation axis direction is also similar to the above-described movement. That is, in the other end part of the heating part 120 in the rotation axis direction, the lubricant puddle 171 is generated, by the scraping of the lubricant by the edge part 151, on the upstream side of the edge part 151 in the belt rotation direction, the lubricant puddle 171 is conveyed in the direction from the central part side of the heating belt 122 in the rotation axis direction towards the other end part of the heating belt 122 in the rotation axis direction, and the lubricant puddle 171 then arrives at the convex part 154 situated on the central part side of the heating belt 122 in the rotation axis direction relative to the other end of the heating belt 122 in the rotation axis direction to be blocked by the convex part 154 and remain in the vicinity of the convex part 154.

As above, the heating part 120 is configured so that the lubricant 126 can be inhibited from leaking out from the both ends of the heating belt 122 in the rotation axis direction to the outside of the heating belt 122 by the convex parts 153 and 154 provided at the both end parts of the edge part 151 in the Y-axis direction.

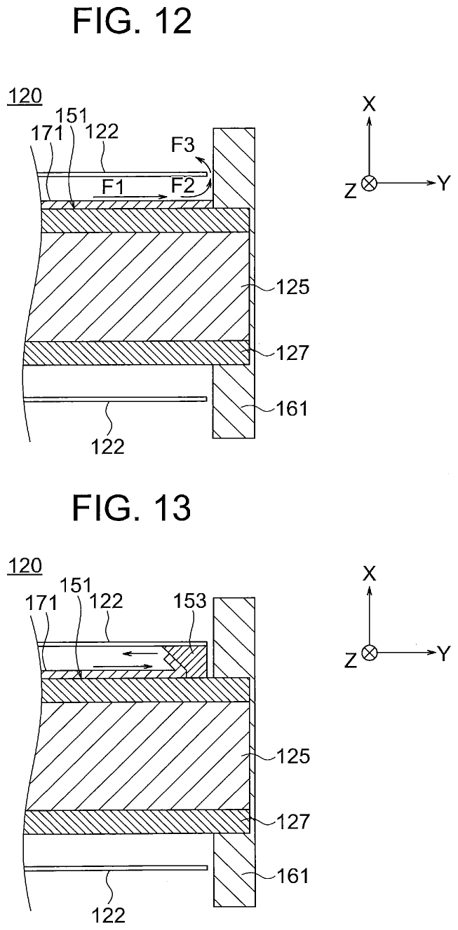

Here, as a target of comparison, the movement of the lubricant 126 in a heating part 120 configured without including the convex parts 153 and 154 is shown in FIG. 11 and FIG. 12.

When the heating belt 122 rotates, part of the lubricant 126 is scraped off by the edge part 151, by which the lubricant puddle 171 develops on the upstream side in the belt rotation direction of the edge part 151 as shown in FIG. 11 and FIG. 12.

The lubricant puddle 171 . . . in FIG. 12, on the upstream side (upper side in FIG. 12) in the belt rotation direction of the edge part 151, the lubricant puddle 171 is conveyed in such a way as to be pushed in the direction (the direction indicated by the arrow F1) from the central part side of the heating belt 122 in the rotation axis direction (the Y-axis direction) towards one end part of the heating belt 122 in the rotation axis direction. In this case, since the convex part 153 is not provided, the lubricant puddle 171 is conveyed to one end of the heating belt 122 in the rotation axis direction, the lubricant puddle 171 arrives at the one end of the heating belt 122 in the rotation axis direction, and then the lubricant puddle 171 moves in the direction of the arrow F2 along the belt contact part of the support 161 and leaks out in the direction of the arrow F3 (i.e., to the outside of the heating belt 122) through a gap between the one end of the heating belt 122 in the rotation axis direction and the belt contact part of the support 161.

If the lubricant puddle 171 thereafter keeps on leaking out to the outside of the heating belt 122, on the outer circumferential surface side of the heating belt 122, an adhesion range of the lubricant 126 spreads from the one end part side in the rotation axis direction towards the central part side in the rotation axis direction. As above, if the convex parts 153 and 154 are not provided, the lubricant 126 leaks out to the outside of the heating belt 122 and there arises a possibility that the heat transmission from the heating belt 122 to the image on the medium M at the time of fixing the image on the medium M becomes insufficient and a printing defect occurs.

In contrast, in the fixing unit 30 in this embodiment, thanks to the provision of the convex parts 153 and 154, the lubricant 126 can be inhibited from leaking out to the outside of the heating belt 122 and thus the occurrence of a printing defect can be inhibited.

### 4. SUMMARY AND EFFECT

As described above, in this embodiment, the fixing unit 30 as a fixing device is provided with the heating belt 122 as a rotatable heating member (i.e., an annular belt) in a tubular shape, the pressing roller 131 as a pressing member that is provided to face the outer circumferential surface of the heating belt 122, makes contact with a part of the outer circumferential surface of the heating belt 122, and forms the nip part 150, as the nip region through which the medium M passes, between the pressing member and the heating belt 122, the thermal diffusion member 125 as a contact member that is provided on the inner circumferential side relative to the heating belt 122 and makes contact with a part of the inner circumferential surface of the heating belt 122 on the pressing roller 131 side, the lubricant 126 applied between the inner circumferential surface of the heating belt 122 and the thermal diffusion member 125, and the convex parts 153 and 154 as contacting members provided to make contact with parts of the inner circumferential surface of the heating belt 122 outside the nip part 150 and on end part sides in the rotation axis direction of the heating belt 122.

More specifically, the edge part 151 extends in the rotation axis direction of the heating belt 122 (the Y-axis direction) and is provided vertically to make contact with the inner circumferential surface of the heating belt 122, the edge part 151 is situated on a part of the thermal diffusion member 125 on the upstream side in the belt rotation direction of the heating belt 122, and the convex part 153 and the convex part 154 are respectively provided at parts of the edge part 151 on the upstream side in the belt rotation direction of the heating belt 122 and on one end part side and the other end part side in the rotation axis direction of the heating belt 122 (the Y-axis direction).

In other words, the edge part 151 is a part that is in contact with the inner circumferential surface of the heating belt 122 and generates the lubricant puddle 171 by scraping off the lubricant 126 which adheres to the inner circumferential surface of the heating belt 122 and is conveyed when the heating belt 122 rotates in the belt rotation direction, and in the edge part 151, the convex part 153 is provided on one end part side in the rotation axis direction of the heating belt 122 (the Y-axis direction) and the convex part 154 is provided on the other end part side.

As above, the fixing unit 30 is capable of inhibiting the lubricant 126 accumulating at the edge part 151 from leaking out to the outside of the heating belt 122 from the both ends of the heating belt 122 in the rotation axis direction by the convex parts 153 and 154 provided on the edge part 151. Accordingly, with the fixing unit 30, occurrence of a printing defect can be inhibited. Since the fixing unit 30 employs the direct heating method of heating the nip part 150 directly with the heat generated by the heater 121, the lubricant 126 is likely to be softened by the heat and move and the lubricant puddle 171 is likely to develop. Thus, in fixing devices employing the direct heating method like the fixing unit 30, the inhibition of the leakage of the lubricant 126 by the convex parts 153 and 154 is especially effective.

Further, since the fixing unit 30 is capable of inhibiting the lubricant 126 from leaking out to the outside of the heating belt 122, loss of the lubricant 126 can be held down. Thus, the fixing unit 30 also has an advantage of eliminating troublesome work such as increasing the amount of the lubricant 126 applied to the thermal diffusion member 125 based on expected loss of the lubricant 126.

Furthermore, in the fixing unit 30, the convex parts 153 and 154 inhibiting the leakage of the lubricant 126 are provided to make contact with parts of the inner circumferential surface of the heating belt 122 outside the nip part 150 (specifically, on the upstream side in the belt rotation direction relative to the nip part 150).

Here, suppose that the convex parts 153 and 154 are provided to make contact with parts of the inner circumferential surface of the heating belt 122 within the nip part 150, these convex parts 153 and 154 cause unevenness of the heating belt 122 within the nip part 150 and it becomes impossible to maintain the heating belt 122 flat in the nip part 150. If the heating belt 122 becomes uneven within the nip part 150 as above, nip pressure in the nip part 150 becomes uneven and there arises a possibility of occurrence of defective fixing of the toner images.

Therefore, in the fixing unit 30 in this embodiment, the convex parts 153 and 154 are provided to make contact with parts of the inner circumferential surface of the heating belt 122 outside the nip part 150, by which the heating belt 122 can be maintained flat in the nip part 150 and the occurrence of the defective fixing can be inhibited.

### 5. OTHER EMBODIMENTS

### 5-1. Modification Example 1

It has been assumed in the above-described embodiment that each of the convex parts 153 and 154 is in a quadrangular shape as viewed in the Z-axis direction and their inner surfaces facing each other (referred to as lubricant contacting surfaces since they are surfaces contacting the lubricant puddle 171) are orthogonal to the rotation axis direction of the heating belt 122 (the Y-axis direction).

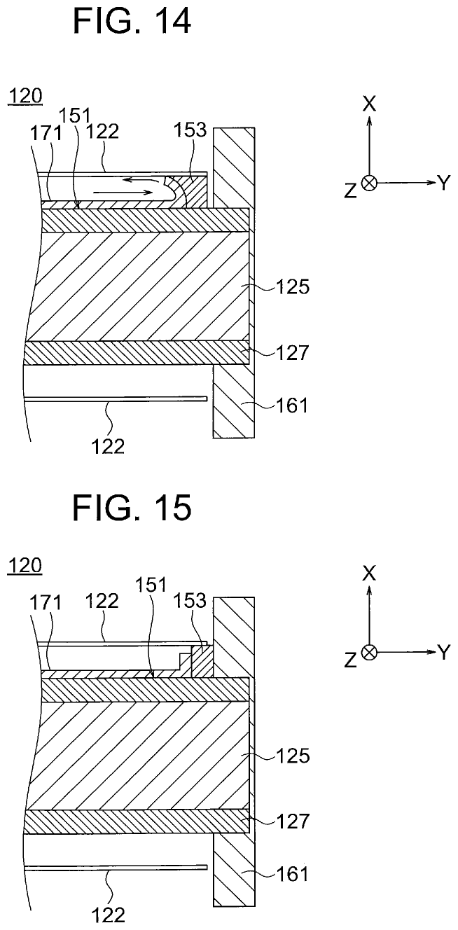

However, the convex parts 153 and 154 are not limited to such a configuration. For example, as shown in FIG. 13 and FIG. 14, the lubricant contacting surface of each convex part 153, 154 may be formed in a shape that becomes closer to the central side in the Y-axis direction of the heating belt 122 with the increase in the distance from the edge part 151 of the support 127.

In this case, for example, it is possible to form the lubricant contacting surface with a vertical surface orthogonal to the rotation axis direction of the heating belt 122 and an inclined surface inclined with respect to the rotation axis direction as shown in FIG. 13; alternatively, it is possible to form the lubricant contacting surface with a curved surface as shown in FIG. 14. In either case, each convex part 153, 154 is facilitated to guide the lubricant puddle 171 arriving at the lubricant contacting surface towards the central side of the heating belt 122 in the rotation axis direction along the lubricant contacting surface.

### 5-2. Modification Example 2

Further, while the convex parts 153 and 154 are provided on the support 127 in the above-described embodiment, the convex parts 153 and 154 are not limited to this example and can also be provided not on the support 127 but on the supports 161 and 162 as shown in FIG. 15, for example. The support 162 and the convex part 154 are not shown in FIG. 15.

In this case, as shown in FIG. 15, it is desirable if the convex part 153 projecting from the support 161 towards the central side of the heating belt 122 in the rotation axis direction is inserted between the edge part 151 of the support 127 and the heating belt 122. Also in this case, the position of the convex part 153 is substantially the same as that in the above-described embodiment, and thus the same effects as in the above-described embodiment can be obtained.

### 5-3. Modification Example 3

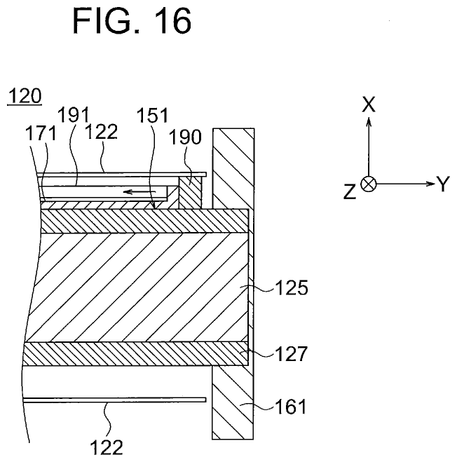

In the above-described embodiment, the leakage of the lubricant 126 is inhibited by the convex parts 153 and 154 provided on the support 127. However, the configuration for inhibiting the leakage of the lubricant 126 is not limited to this example and it is also possible, for example, to provide a roller 190 at the position of each convex part 153, 154 instead of each convex part 153, 154 as shown in FIG. 16. The roller 190 is a roller formed with an independent-foam sponge member and having a shaft 191 extending in the rotation axis direction of the heating belt 122 as the rotation axis, and is configured to rotate accompanying the rotation of the heating belt 122 while remaining in close contact with the edge part 151 of the support 127 and the inner circumferential surface of the heating belt 122.

In this case, the roller 190 is capable of preventing the lubricant 126 from leaking out to the outside of the heating belt 122 by absorbing the arriving lubricant puddle 171. The shaft 191 may also be formed to have the shape of a screw which conveys the lubricant puddle 171 by rotation, towards the central part of the heating belt 122 in the rotation axis direction. This facilitates guiding the lubricant puddle 171 towards the central part of the heating belt 122 in the rotation axis direction, by which the leakage of the lubricant 126 can be inhibited further.

The convex parts 153 and 154 provided on the support 127 may also be formed with independent-foam sponge. Further, it is also possible to provide, between the convex parts 153 and 154, a screw-shaped shaft 191 which rotates in the same direction as the heating belt 122, thereby conveying the lubricant puddle 171 towards the central part of the heating belt 122 in the rotation axis direction.

### 5-4. Modification Example 4

While the convex parts 153 and 154 are respectively provided at the Y-axis direction both end parts of the edge part 151 of the support 127 in the above-described embodiment, the convex parts 153 and 154 are not limited to this example and it is also possible to employ a configuration in which one of the convex parts 153 and 154 is not provided. That is, it is also possible to employ a configuration in which the convex part 153 (or the convex part 154) is provided at only one end part out of the Y-axis direction both end parts of the edge part 151 of the support 127.

A conceivable case where the convex part 153 (or the convex part 154) is providing at only one end part out of the Y-axis direction both end parts of the edge part 151 of the support 127 is, for example, a case where the heating belt 122 has previously been displaced towards the support 162's side (or the support 161's side), there is no gap between the heating belt 122 and the support 162 (or the support 161) and there is a gap between the heating belt 122 and the support 161 (or the support 162).

### 5-5. Modification Example 5

While the present invention is applied to the image forming device 200 in the above-described embodiment, the present invention is not limited to the application to the image forming device 200 but is applicable to various types of image forming devices including a fixing device like the fixing unit 30 (i.e., of the electrophotographic type). For example, the present invention is applicable also to image forming devices such as copy machines, multi-function peripherals and facsimile machines as the image forming devices including the fixing device.

### 5-6. Modification Example 6

Further, the present invention is not limited to the above-described embodiments. That is, the scope of application of the present invention ranges also to embodiments obtained by arbitrarily combining parts or wholes of some of the above-described embodiments and embodiments obtained by extracting parts from the above-described embodiments.

### 5-7. Modification Example 7

While the heat generated by the heater 121 is conducted to the heating belt 122 via the thermal diffusion member 125 in the fixing device of the above-described embodiments, it is also possible to employ a configuration in which the thermal diffusion member 125 is not provided and the heat generated by the heater 121 is conducted to the heating belt 122 via the glass (i.e., glass coating layer) coated on a surface of the heater 121.

### 5-8. Modification Example 8

While the thermal diffusion member 125 is coated with glass in the fixing device of the above-described embodiments, it is also possible that the thermal diffusion member 125 is coated with resin (i.e., a resin coating layer) instead of glass. It is possible to employ a material including resin such as polyimide (PI) or PolyEtherEtherKetone (PEEK) as the resin coated on the thermal diffusion member 125. In particular, it is preferable to use a resin material with excellent heat resistance such as Polyamideimide (PAI) as the resin coated on the thermal diffusion member 125.

Further, the resin coated on the thermal diffusion member 125 may contain materials such as carbon black or metallic elements (zinc or the like) as thermally conductive filler particles. In this case, the resin coating can have an advantageous effect of improving thermal conductivity.

Alternatively, the resin coated on the thermal diffusion member 125 may contain a fluorine-based resin such as PolyTetraFluoroEethylene (PTFE), a copolymer of Tetrafluoroethylene and Perfluoroalkoxyethylene (PFA), or the like, as filler particles. In this case, durability can be improved as compared to adding the above-described thermally conductive filler particles, and friction between the annular belt and the resin coating layer can be reduced.

The present invention is widely applicable to printers of the electrophotographic type and the like, for example.

### 6. DESCRIPTION OF REFERENCE CHARACTERS

200: image forming device, 30: fixing unit, 110: housing, 120: heating part, 130: pressing part, 140: connector, 121: heater, 122: heating belt (annular belt), 123: temperature sensor, 124: thermal conduction plate, 125: thermal diffusion member (thermal diffusion plate), 126: lubricant, 127, 128, 161, 162: support, 129: compression spring, 150: nip part, 151, 152: edge part, 153, 154: convex part (contacting member), 171: lubricant puddle, 190: roller, 191: shaft, M: medium.

What is claimed is:

1. A fixing device comprising:
a rotatable annular belt with lubricant on an inner circumferential surface of the annular belt;
a pressing roller that is provided to face an outer circumferential surface of the annular belt and makes contact with a part of the outer circumferential surface of the annular belt, thereby forming a nip region between the pressing roller and the annular belt;
a thermal diffusion plate that is provided on an inner circumferential side relative to the annular belt and makes contact with a part of an inner circumferential surface of the annular belt on the pressing roller's side; and
a convex part provided so as to make contact with a part of the inner circumferential surface of the annular belt outside the nip region and on an end part's side in a rotation axis direction of the annular belt.

2. The fixing device according to claim 1, further comprising an edge part provided vertically so as to make contact with the inner circumferential surface of the annular belt on a part of the thermal diffusion plate on an upstream side of a rotation direction of the annular belt,
wherein the convex part is provided on a part of the edge part on the upstream side of the rotation direction of the annular belt.

3. The fixing device according to claim 2, wherein the convex part is projecting from the edge part towards the upstream side of the rotation direction of the annular belt.

4. The fixing device according to claim 2, further comprising a support that is provided on an end part's side in the rotation axis direction of the annular belt and supports the annular belt, wherein the convex part is projecting from the support towards a central part's side in the rotation axis direction of the annular belt.

5. The fixing device according to claim 2, wherein a surface of the convex part on a central part's side in the rotation axis direction of the annular belt is orthogonal to the rotation axis direction of the annular belt.

6. The fixing device according to claim 2, wherein a surface of the convex part on a central part's side in the rotation axis direction of the annular belt is in a shape that becomes closer to the central part's side in the rotation axis direction of the annular belt with an increase in distance from the edge part.

7. The fixing device according to claim 1, wherein
the convex part is a roller having a shaft extending in the rotation axis direction of the annular belt as a rotation axis, and
the shaft is in a screw shape to convey the lubricant towards a central part of the annular belt in the rotation axis direction by rotating.

8. An image forming device comprising the fixing device according to claim 1.
